(19) United States
(12) Patent Application Publication
(10) Pub. No.: US 2011/0188003 A1
(43) Pub. Date: Aug. 4, 2011

(54) ILLUMINATION DEVICE AND PROJECTION-TYPE IMAGE DISPLAY DEVICE

(75) Inventors: Ryo Furutachi, Tokyo (JP); Michio Oka, Tokyo (JP); Kaoru Kimura, Tokyo (JP)

(73) Assignee: SONY CORPORATION, Tokyo (JP)

(21) Appl. No.: 13/014,006

(22) Filed: Jan. 26, 2011

(30) Foreign Application Priority Data
Feb. 4, 2010 (JP) 2010-023597

(51) Int. Cl. G03B 21/14; F21S 6/00; G02B 27/20; F21V 5/04; F21V 11/00; F21V 17/02; F21V 19/02

(52) U.S. Cl. 353/34; 362/257; 362/259; 362/311.01; 362/277; 362/285

(57) ABSTRACT

A light source having (a) a light emitter that emits a light beam along a first axis, the light beam having a highest degree of anisotropic coherency in a second axis perpendicular to the first axis; and (b) a light multiplexer positioned optically downstream of the light emitter, the multiplexer having an axis of multiplexing perpendicular to the first axis, the second axis and the axis of multiplexing being oriented at an angle with respect to each other that is other than 0, 90, 180 and 270 degrees.

### RELATED APPLICATION DATA

This application claims the benefit of priority to Japanese patent Application JP 2010-023597 filed in the Japan Patent Office on Feb. 4, 2010, which is hereby incorporated by reference in its entirety to the extent permitted by law.

### BACKGROUND OF THE INVENTION

The invention generally relates to illumination devices in which light having an in-plane anisotropy in coherency, such as laser light, is used, and to a projection-type image display devices provided with such illumination devices.

In general, lamp light sources, such as a high-pressure mercury lamps and xenon lamps, are often used in an illumination devices provided in projection-type image display devices such as projectors. In recent years, a laser light source has been developed as a substitute lamp light source due to its notable characteristics of high energy efficiency, high color reproducibility, and high durability. For the purpose of ensuring an in-plane uniformity of illumination light, an optical member utilizing a fly-eye lens and so forth is provided in the illumination device. The illumination device divides light flux exiting from the laser light source with the fly-eye lens, and multiplexes the divided light fluxes with a condenser lens, to realize uniform illumination.

However, when the dividing and the multiplexing of the light fluxes are performed on a laser light which is high in coherency, an interference fringe is likely to occur on an irradiated surface, due to high coherency thereof.

To address this issue, Japanese Unexamined Patent Application Publication No. H11-271213 (JP-H11-271213A) proposes a technique, in which a deflection mirror is provided between a laser light source and a fly-eye lens, and the deflection mirror is driven rotatably to move (or to rotate) the interference fringe generated on an irradiated surface. This method apparently reduces the interference fringe, since accumulated amounts of light even out over the irradiated surface as a whole by moving the interference fringe. In addition, Japanese Unexamined Patent Application Publication No. 2006-49656 (JP2006-49656A) proposes a technique, in which an optical member for changing an apparent optical path length with respect to each light flux, divided using an array lens, is provided separately, and a difference in the optical path lengths among the light fluxes is utilized to reduce the interference fringe.

### SUMMARY OF THE INVENTION

The technique disclosed in JP-H11-271213A is provided with a separate mechanism for rotatably driving a deflection mirror. The technique disclosed in JP2006-49656A includes a separate optical member having a special shape. Both configurations are disadvantageous in terms of complex device configuration and high costs.

It is desirable to provide an illumination device having a configuration which is simple and low in costs, and capable of allowing an interference fringe less visible, and a projection-type image display device provided with the illumination device.

In an embodiment, the invention provides a light source, comprising: a light emitter that emits a light beam along a first axis, the light beam having a highest degree of anisotropic coherency in a second axis perpendicular to the first axis; and a light multiplexer positioned optically downstream of the light emitter, the multiplexer having an axis of multiplexing perpendicular to the first axis, the second axis and the axis of multiplexing being oriented at an angle with respect to each other that is other than 0, 90, 180 and 270 degrees.

In an embodiment, the light emitter is a laser.

In an embodiment, the laser is a laser diode.

In an embodiment there is in included an optical member which divides light.

In an embodiment, the optical member which divides light is a fly-eye lens.

In an embodiment there is included a lens between the light emitter and the light multiplexer.

In an embodiment, the lens is a cylindrical lens.

In an embodiment, the multiplexer is a condenser lens.

In an embodiment, the multiplexer is a rod-type light integrator.

In an embodiment, the optical member that divides light is a rod-type light integrator.

In an embodiment, there is included a dove-prism between the light emitter and the light multiplexer.

In an embodiment there is included a mirror between the light emitter and the light multiplexer.

In an embodiment, there is included: a cylindrical lens between the light emitter and the light multiplexer; a condenser lens as the light multiplexer; and a fly-eye lens between the cylindrical lens and the fly-eye lens, wherein, the light emitter is configured to emit the light beam along the first axis to have a highest degree of anisotropic coherency in a third axis perpendicular to the first axis, the axis of multiplexing and the third axis are oriented at an angle of 0, 90, 180 or 270 degrees with respect to each other, and the cylindrical lens is rotated about the first axis relative to the axis of multiplexing to cause the axis of multiplexing and the second axis to be oriented at an angle with respect to each other of other than 0, 90, 180 and 270 degrees.

In an embodiment there is included: a condenser lens as the light multiplexer; and a fly-eye lens between the cylindrical lens and the fly-eye lens, wherein, the light emitter is configured to emit the light beam along the first axis to have a highest degree of anisotropic coherency in a third axis perpendicular to the first axis, the light emitter is rotated about the first axis relative to the axis of multiplexing to cause the axis of multiplexing and the second axis to be oriented at an angle with respect to each other of other than 0, 90, 180 and 270 degrees.

In an embodiment there is included: a condenser lens as the light multiplexer; and a fly-eye lens between the cylindrical lens and the fly-eye lens, wherein, the light emitter is configured to emit the light beam along the first axis to have a highest degree of anisotropic coherency in a third axis perpendicular to the first axis, the axis of multiplexing and the third axis are oriented at an angle of 0, 90, 180 or 270 degrees with respect to each other, and the fly-eye lens is rotated about the first axis relative to the axis of multiplexing to cause the axis of multiplexing and the second axis to be oriented at an angle with respect to each other of other than 0, 90, 180 and 270 degrees.

In an embodiment there is included: a cylindrical lens between the light emitter; and a rod-type light integrator as the multiplexer, wherein, the light emitter is configured to emit the light beam along the first axis to have a highest degree of anisotropic coherency in a third axis perpendicular to the first axis, the axis of multiplexing and the third axis are oriented at an angle of 0, 90, 180 or 270 degrees with respect to each other, and the cylindrical lens is rotated about the first axis relative to the axis of multiplexing to cause the axis of multiplexing and the second axis to be oriented at an angle with respect to each other of other than 0, 90, 180 and 270 degrees.

In an embodiment there is included a rod-type light integrator, wherein, the light emitter is configured to emit the light beam along the first axis to have a highest degree of anisotropic coherency in a third axis perpendicular to the first axis, the light emitter is rotated about the first axis relative to the axis of multiplexing to cause the axis of multiplexing and the second axis to be oriented at an angle with respect to each other of other than 0, 90, 180 and 270 degrees.

In an embodiment there is included a rod-type light integrator, wherein, the light emitter is configured to emit the light beam along the first axis to have a highest degree of anisotropic coherency in a third axis perpendicular to the first axis; and the axis of multiplexing and the third axis are oriented at an angle of 0, 90, 180 or 270 degrees with respect to each other, and the cylindrical lens is rotated about the first axis relative to the axis of multiplexing to cause the axis of multiplexing and the second axis to be oriented at an angle with respect to each other of other than 0, 90, 180 and 270 degrees.

In an embodiment there is included a rod-type light integrator, wherein, the light emitter is configured to emit the light beam along the first axis to have a highest degree of anisotropic coherency in a third axis perpendicular to the first axis, the light emitter is rotated about the first axis relative to the axis of multiplexing to cause the axis of multiplexing and the second axis to be oriented at an angle with respect to each other of other than 0, 90, 180 and 270 degrees.

In an embodiment there is included a rod-type light integrator, wherein, the light emitter is configured to emit the light beam along the first axis to have a highest degree of anisotropic coherency in a third axis perpendicular to the first axis; and the rod-type integrator is rotated about the first axis relative to the third axis to cause the axis of multiplexing and the second axis to be oriented at an angle with respect to each other of other than 0, 90, 180 and 270 degrees.

In an embodiment, the invention provides an illumination device with a light source comprising (a) a light emitter that emits a light beam along a first axis with a highest degree of anisotropic coherency in a second axis perpendicular to the first axis and (b) a light multiplexer positioned optically downstream of the light emitter, the multiplexer having an axis of multiplexing perpendicular to the first axis, the second axis and the axis of multiplexing are oriented at an angle with respect to each other that is other than 0, 90, 180 and 270 degrees.

In an embodiment, the invention provides a display device with an illumination device comprising (a) a light emitter that emits a light beam along a first axis with a highest degree of anisotropic coherency in a second axis perpendicular to the first axis and (b) a light multiplexer positioned optically downstream of the light emitter, the multiplexer having an axis of multiplexing perpendicular to the first axis, the second axis and the axis of multiplexing are oriented at an angle with respect to each other that is other than 0, 90, 180 and 270 degrees; a light divider configuration to divide light from the illumination device into different beams; and a light synthesizer to combine different light beams from the light divider configuration.

In an embodiment, the light divider comprises a configuration of mirrors and light valves.

In an embodiment, the light synthesizer comprises a dichroic prism.

In an embodiment, the light divider comprises a configuration of mirrors and reflective liquid crystal panels.

In an embodiment, the invention provides a display projector including: an illumination device comprising (a) a light emitter that emits a light beam along a first axis with a highest degree of anisotropic coherency in a second axis perpendicular to the first axis and (b) a light multiplexer positioned optically downstream of the light emitter, the multiplexer having an axis of multiplexing perpendicular to the first axis, the second axis and the axis of multiplexing are oriented at an angle with respect to each other that is other than 0, 90, 180 and 270 degrees; a light divider configuration to divide light from the illumination device into different beams; a light synthesizer to combine different light beams from the light divider configuration; and a projection lens to focus light from the light synthesizer.

In an embodiment, the invention provides a projection display configuration including: an illumination device comprising (a) a light emitter that emits a light beam along a first axis with a highest degree of anisotropic coherency in a second axis perpendicular to the first axis and (b) a light multiplexer positioned optically downstream of the light emitter, the multiplexer having an axis of multiplexing perpendicular to the first axis, the second axis and the axis of multiplexing are oriented at an angle with respect to each other that is other than 0, 90, 180 and 270 degrees; a light divider configuration to divide light from the illumination device into different beams; a light synthesizer to combine different light beams from the light divider configuration; a projection lens to focus light from the light synthesizer; and a display screen onto with light from the projections lens is projected.

In accordance with principles of the invention, the light flux derived from the light flux emitted from the light source is incident on an optical member. When the light flux enters the optical member, the light flux is divided and multiplexed in the optical member, thereby uniformizing an in-plane luminance. Herein, the direction, in which the highest coherency of light appears in the incident light flux entering the optical member, is different from the multiplexing directions in the optical member. Thus, the coherency after the exit thereof from the optical member becomes less visible.

In accordance with principles of the invention, the direction in which the highest coherency of light appears in the incident light flux entering the optical member, is different from the multiplexing directions in the optical member. This makes it possible to allow the coherency after the exit thereof from the optical member less visible, without separately providing, for example, a mechanism for rotatably driving a deflection mirror on an optical path, or a special optical member for changing an apparent optical path with respect to each divided light flux. Therefore, it is possible to make an interference fringe to be less visible with a configuration that is relatively simple and relatively low in cost.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the specification, serve to explain the principles of the invention.

FIG. 1 illustrates an overall configuration of a projection-type display device according to principles of the invention.

FIG. 2 is a perspective view of a cylindrical lens illustrated in FIG. 1.

FIG. 3A illustrates a shape of light emitted from a light source on an XY plane.

FIG. 3B illustrates an arrangement of the cylindrical lens in the XY plane.

FIG. 3C illustrates an arrangement of a fly-eye lens in the XY plane.

FIG. 4 illustrates an overall configuration of a comparative projection-type display device.

FIG. 5A illustrates a relationship between axial directions of light entering a fly-eye lens and arrangement directions of lenses in the fly-eye lens, and illustrates an interference fringe generated on an irradiated surface, according to the comparative projection-type display device.

FIG. 5B illustrates a relationship in arrangement between axial directions of light entering the fly-eye lens and arrangement directions of lenses in the fly-eye lens, and illustrates a state of an interference fringe generated on an irradiated surface, according to principles of the invention.

FIG. 6A illustrates an arrangement of a light emitted from a light source in the XY plane according to a first modification of the configuration of FIG. 1.

FIG. 6B illustrates a state of arrangement of a fly-eye lens in the XY plane according to the first modification.

FIG. 7A illustrates a state of arrangement of a light emitted from a light source in the XY plane according to a second modification of the configuration of FIG. 1.

FIG. 7B illustrates a state of arrangement of a fly-eye lens in the XY plane according to the second modification.

FIG. 8 illustrates an overall configuration of a projection-type display device according to a third modification of the configuration of FIG. 1.

FIG. 9A illustrates a plane shape of a light emitted from a light source in an XY plane.

FIG. 9B illustrates an arrangement of the cylindrical lens in the XY plane.

FIG. 9C illustrates an arrangement of a rod-type light integrator in the XY plane.

FIG. 10A and FIG. 10B are perspective views of the rod-type light integrator illustrated in FIG. 8.

FIG. 11A and FIG. 11B are schematic drawings for describing a principle of the rod-type light integrator illustrated in FIG. 8.

FIG. 12A illustrates light emitted from a light source in the XY plane according to a third modification of the configuration of FIG. 1.

FIG. 12B illustrates a state of arrangement of the rod-type light integrator in the XY plane according to the third modification.

FIG. 13A illustrates a state of arrangement of a light emitted from a light source in the XY plane according to a fourth modification of the configuration of FIG. 1.

FIG. 13B illustrates a state of arrangement of the rod-type light integrator in the XY plane according to the fourth modification of the configuration of FIG. 1.

FIG. 14 illustrates an overall configuration of a projection-type display device according to a fifth modification of the configuration of FIG. 1.

FIG. 15 is a schematic drawing for describing further principles of the invention.

### DETAILED DESCRIPTION OF THE PRESENTLY PREFERRED EMBODIMENTS

In the following, some embodiments of the invention will be described in detail with reference to the accompanying drawings. The description will be given in the following order.

1. Initial Embodiment (A cylindrical lens is inclinedly arranged between a laser light source and a fly-eye lens)

2. First Modification and Second Modification (The laser light source or the fly-eye lens is inclinedly arranged)

3. Third Modification (The cylindrical lens is inclinedly arranged between the laser light source and a rod-type light integrator)

4. Fourth Modification and Fifth Modification (The laser light source or the rod-type light integrator is inclinedly arranged)

5. Sixth Modification (Reflective liquid crystal panels are used)

### Intitial Embodiment

### Configuration of Projection-Type Display Device 1

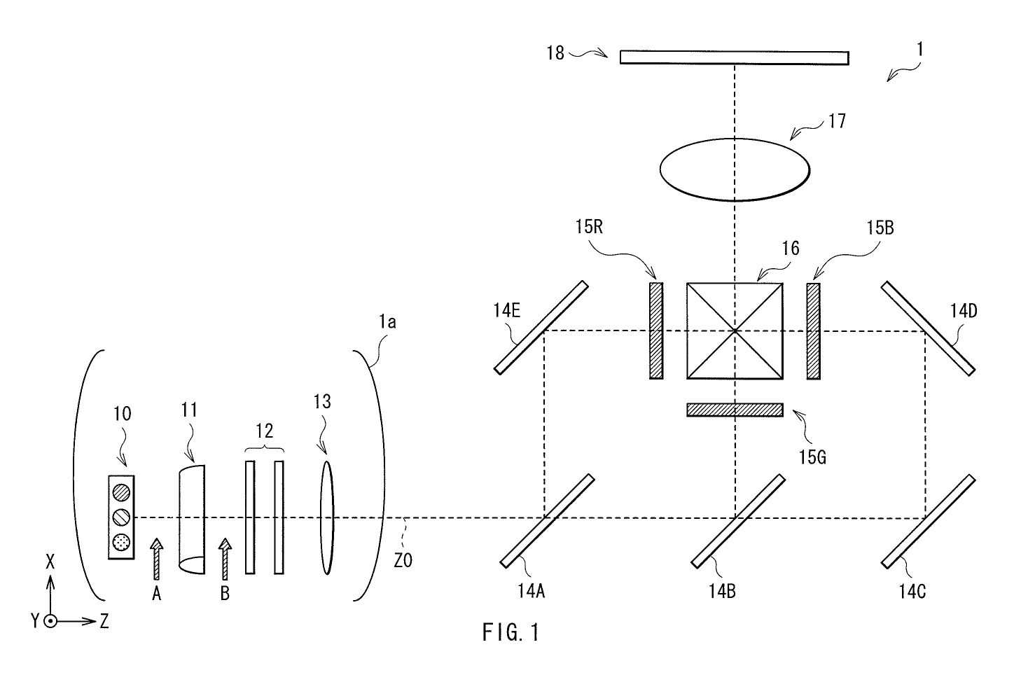

FIG. 1 illustrates a schematic of a configuration of a projection-type display device 1 (a projection-type image display device) according to an embodiment of the invention. The projection-type display device 1 is provided with a laser light source 10, a cylindrical lens 11, a fly-eye lens 12, and a condenser lens 13, which structure an illumination device 1a. Also, the projection-type display device 1 is provided with mirrors 14A to 14E, transmissive liquid crystal panels 15R, 15G, and 15B, a dichroic prism 16, and a projection lens 17, which structure a projection optical system for projecting an image on a screen 18 using an illumination light of the illumination device 1a.

The laser light source 10 may include a red laser element, a green laser element, and a blue laser element, for example (types of colors and the number of colors are not limited thereto). Each of those laser elements can be a semiconductor laser element, a solid laser element, or other suitable element. Also, it is preferable, but not required, that an array laser in which a plurality of laser elements are arranged uniaxially be used. A laser light emitted therefrom may include a far-field pattern (FFP) whose shape is elliptical, for example. That is, a light (or a light flux) exited or emitted from the laser light source 10 (hereinafter may be simply referred to as a “light source exit light”) has an in-plane anisotropy in coherency, i.e., an anisotropy in coherency in a cross section plane of the light flux.

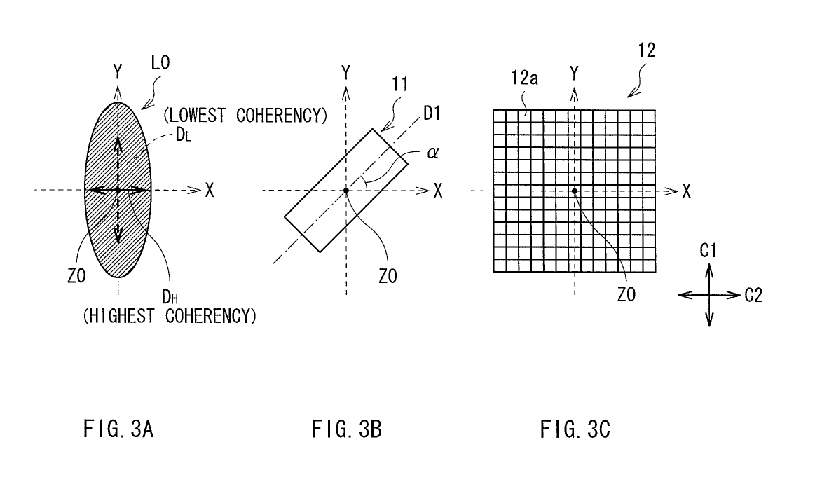

In this embodiment, a shape of the light source exit light L0 is an ellipse having a minor axis in an X-direction and a major axis in a Y-direction in an XY plane, as illustrated in FIG. 3A. In other words, the laser light source 10 is so arranged on an optical axis Z0, that an axial direction D_{H}, in which a highest coherency of light appears, overlaps or coincides with the X-direction and that an axial direction D_{L}, in which a lowest coherency of light appears, overlaps or coincides with the Y-direction in the light source exit light L0. Such a state of arrangement of the laser light source 10 will be hereinafter referred to as a “reference arrangement” of the laser light source 10. Also, a term “plane shape” of a laser light appearing hereinafter refers to a shape in the XY plane.

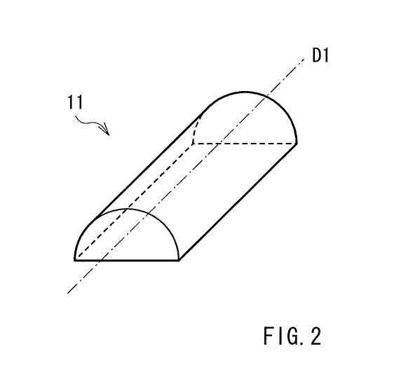

Referring to FIG. 2, the cylindrical lens 11 may be a half-cylindrical lens extending uniaxially in an axial direction D1, i.e., extending in a direction in a cross section plane of the light flux. In this embodiment, the cylindrical lens 11 is so obliquely arranged in an inclined fashion, that the axial direction D1 of the cylindrical lens 11 and the axial direction D_{H}, in which the highest coherency of light appears, are different from each other. More specifically, as illustrated in FIG. 3B, the cylindrical lens 11 is so arranged that the axial direction D1 thereof is rotated from the X-direction around the optical axis Z0 at a predetermined angle α. The angle α is set appropriately to have a value which is larger than zero degree and less than 180 degrees (excluding 90 and 270 degrees). Such a state of arrangement of the cylindrical lens 11 will be hereinafter referred to as an “inclined arrangement” of the cylindrical lens 11.

The fly-eye lens 12 has a configuration in which a plurality of lenses are two-dimensionally arranged, for example, on a substrate. The fly-eye lens 12 spatially divides an incident light flux in accordance with the alignment of the lenses, and allows the divided light fluxes to exit therefrom. As illustrated in FIG. 3C, the fly-eye lens 12 may have a configuration in which a plurality of lenses 12a are arranged (in matrix) along two directions which are orthogonal to each other (i.e., aligning directions C1 and C2), for example. In this embodiment, the fly-eye lens 12 is so arranged on the optical axis Z0, that the aligning direction C1 of the lenses 12a overlaps or coincides with the Y-direction, and that the aligning direction C2 of the lenses 12a overlaps or coincides with the X-direction. Such a state of arrangement of the fly-eye lens 12 will be hereinafter referred to as a “reference arrangement” of the fly-eye lens 12.

The condenser lens 13 serves to multiplex the lights divided in the fly-eye lens 12. The multiplexing by the condenser lens 13 is carried out along the aligning directions of the lenses 12a in the fly-eye lens 12. That is, in this embodiment, directions of multiplexing by the condenser lens 13 are in the X-direction and the Y-direction.

The condenser lens 13 and the fly-eye lens 12 correspond to an illustrative example of an optical member. The fly-eye lens 12 and the condenser lens 13 are arranged in combination to divide the incident light flux derived from the light source exit light L0 and to multiplex the divided light fluxes derived from the light source exit light L0, so as to thereby uniformize an in-plane luminance.

The mirrors 14A to 14E separate the light (the illumination light) emitted from the illumination device 1a into color lights of red (R) light, green (G) light, and blue (B) light, and perform an optical-path conversion on the separated color lights to guide each of the separated color lights to a liquid crystal panel of a corresponding color (i.e., to a transmissive liquid crystal panel 15R, 15G, or 15B). More specifically, each of the mirrors 14A and 14E performs the optical-path conversion by reflection on the red light to guide the same to the transmissive liquid crystal panel 15R. Similarly, the mirror 14B guides the blue light to the transmissive liquid crystal panel 15B, and each of the mirrors 14C and 14D guides the green light to the transmissive liquid crystal panel 15G. Among those mirrors 14A to 14E, the mirror 14A selectively transmits the green light and the blue light therethrough, and the mirror 14B selectively transmits the green light therethrough.

The transmissive liquid crystal panels 15R, 15G, and 15B modulate the red light, the green light, and the blue light based on an image signal, and create displaying-image lights for red, green, and blue, respectively. Each of the transmissive liquid crystal panels 15R, 15G, and 15B may have an unillustrated configuration in which a liquid crystal layer is sealed between a pair of substrates opposed to each other, and in which a polarizer is provided on each of a light-incident side and a light-exit side of the pair of substrates, for example. When a predetermined voltage corresponding to the image signal is applied to each of the liquid crystal layers of the transmissive liquid crystal panels 15R, 15G, and 15B, the color lights passing through the liquid crystal layers thereof are modulated, and exit therefrom as image lights, respectively.

The dichroic prism 16 may be a color-synthesizing prism, which can be a cross-dichroic prism or other suitable optical member, for example. The dichroic prism 16 serves to synthesize the image lights of red, green, and blue described before. The projection lens 17 serves to project, in an enlarged fashion, the image light synthesized by the dichroic prism 16.

### [Operation and Effect of Projection-Type Display Device 1]

An operation and an effect of the projection-type display device 1 will now be described with reference to FIG. 1 to FIG. 5B.

In the projection-type display device 1, the light emitted from the laser light source 10 (i.e., the light source exit light L0) first passes through the cylindrical lens 11, and then enters the fly-eye lens 12, in the illumination device 1a. When the light source exit light L0 is incident on the fly-eye lens 12, an incident light (an incident light L1 described later) thereof is divided corresponding to the aligning directions of the lenses 12a. Then, the light divided in the fly-eye lens 12 is multiplexed in the condenser lens 13, and the multiplexed light exits from the condenser lens 13. Thus, the in-plane luminance of the exit light (the illumination light) from the illumination device 1a is uniformized. Then, the illumination light is separated into the three color lights of the red light, the green light, and the blue light, which are then guided and enter the transmissive liquid crystal panels 15R, 15G, and 15B, respectively. Then, these color lights are modulated in the transmissive liquid crystal panels 15R, 15G, and 15B, and the modulated color lights exit therefrom as the image lights, respectively. Then, the image lights of the respective colors are synthesized in the dichroic prism 16. Then, the synthesized light is projected on the screen 18 in an enlarged fashion by the projection lens 17. Thereby, image displaying is performed.

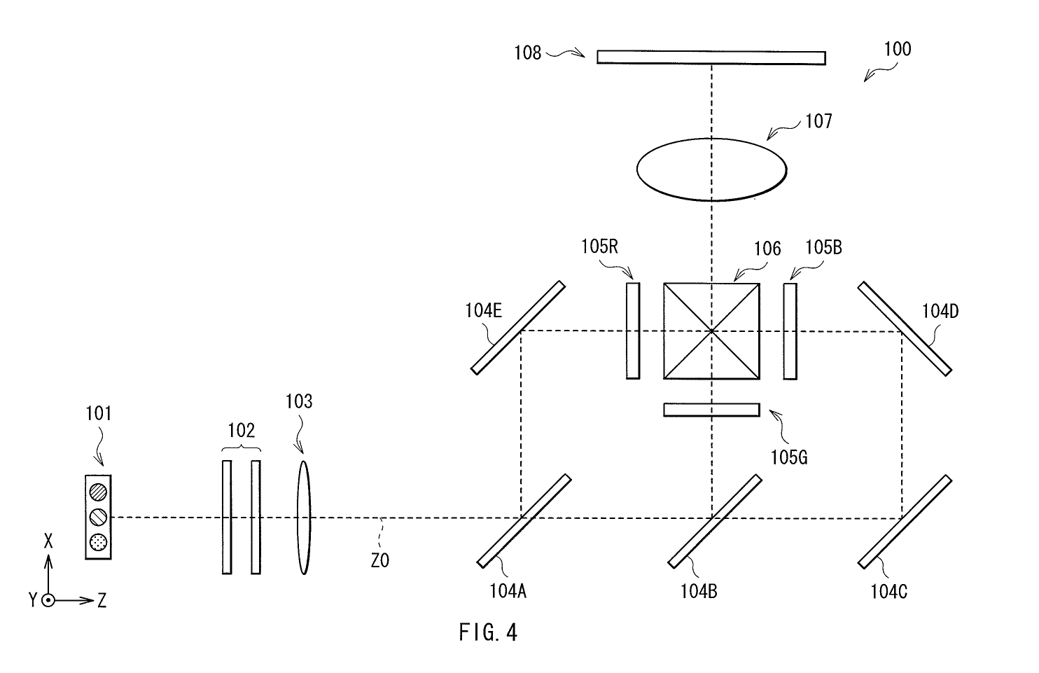

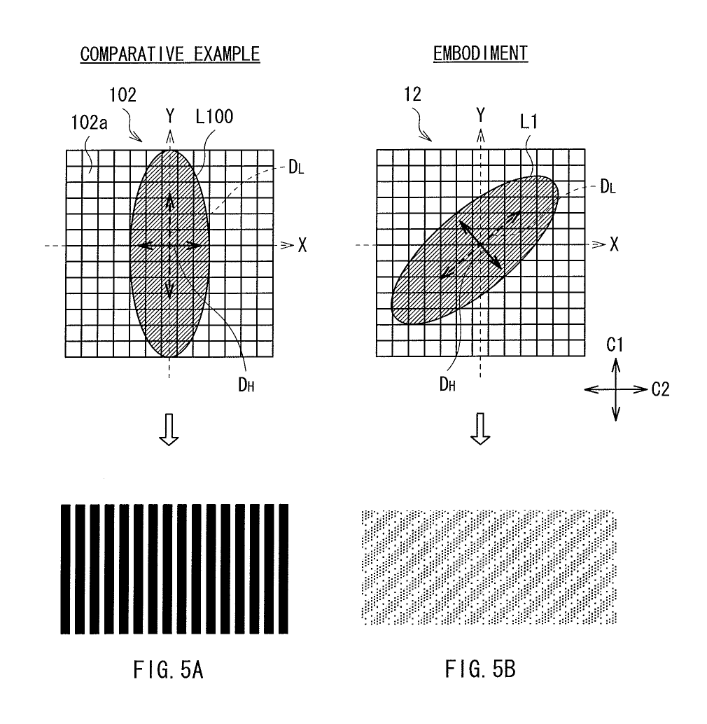

In the following, a projection-type display device 100 according to a comparative example will be described with reference to FIGS. 4 and 5A. FIG. 4 illustrates an overall configuration of the projection-type display device 100 according to the comparative example. FIG. 5A illustrates a relationship in arrangement between a light source exit light L100 and a fly-eye lens 102 in the projection-type display device 100, and illustrates a state of an interference fringe generated on an irradiated surface. The projection-type display device 100 is provided with a laser light source 101, a fly-eye lens 102, a condenser lens 103, mirrors 104A to 104E, transmissive liquid crystal panels 105R, 105G, and 105B, a dichroic prism 106, and a projection lens 107, which are provided along an optical axis Z0.

In the projection-type display device 100 having the configuration described before, each of the laser light source 101 and the fly-eye lens 102 is arranged to have the “reference arrangement” according to this embodiment. That is, as illustrated in an upper illustration in FIG. 5A, the laser light source 101 is so arranged that the axial direction D_{H}, in which the highest coherency of light appears, in the light source exit light L100 overlaps or coincides with the X-direction, and that the axial direction D_{L}, in which the lowest coherency of light appears, in the light source exit light L100 overlaps or coincides with the Y-direction. On the other hand, the fly-eye lens 102 is so arranged that the aligning directions of lenses 102a overlap or coincide with the X-direction and the Y-direction. However, when both of the laser light source 100 and the fly-eye lens 102 are disposed to have the reference arrangements, the direction D_{H} in the light source exit light L100 and the aligning directions of the lenses 102a (i.e., the directions of multiplexing performed by the condenser lens 103) overlap or coincides with each other in the X-direction. When such overlapping or coinciding of the axial direction is generated, the multiplexing is performed along the direction D_{H} in the light source exit light L100 in which the highest coherency of light appears. Thus, the illumination light after the exit from the condenser lens 103 is more likely to generate the interference fringe on the irradiated surface as illustrated in a lower illustration in FIG. 5A.

In contrast, according to this embodiment, the cylindrical lens 11 is disposed to have the “inclined arrangement” between the laser light source 10 and the fly-eye lens 12. That is, the cylindrical lens 11 is so arranged that the axial direction D1 thereof is rotated around the optical axis Z0 at the angle α. Thereby, when the light source exit light L0 (a light traveling along an optical path A) passes through the cylindrical lens 11, the plane shape of the light source exit light L0 is rotated in accordance with the angle α, and then exits from the cylindrical lens 11. Thus, the axial direction D_{H} in the light L1, which enters the fly-eye lens 12 after exiting from the cylindrical lens 11 (a light traveling along an optical path B), differs from the lens-aligning directions C1 and C2 (which are equivalent to the X-direction and the Y-direction here) mutually, as illustrated in an upper illustration in FIG. 5B. This makes the axial direction D_{H} of the incident light L1 entering the fly-eye lens 12 and the directions of multiplexing by the condenser lens 13 to be different from one another, thereby preventing the multiplexing from occurring along the axial direction D_{H} in which the coherency is the highest. Hence, the illumination light, after exiting from the condenser lens 13, is less likely to generate the interference fringe, or makes the interference fringe less visible, on the irradiated surface as illustrated in a lower illustration in FIG. 5B.

As set forth in the foregoing, according to this embodiment, the illumination device includes the laser light source 10, the cylindrical lens 11, the fly-eye lens 12, and the condenser lens 13, which are disposed in this order along the optical axis Z0. Further, in the illumination device, each of the laser light source 10 and the fly-eye lens 12 is arranged to have the “reference arrangement”, whereas the cylindrical lens 11 is arranged to have the “inclined arrangement” (is rotated in the xy plane). This makes it possible to allow the axial direction D_{H} of the incident light L1 entering the fly-eye lens 12 and the directions of multiplexing by the condenser lens 13 to be different from one another, and thereby to prevent light rays from being multiplexed along the axial direction D_{H} in which the coherency is the highest. Therefore, it is possible to allow the interference fringe on the irradiated surface less visible.

In currently-available techniques, for example, a mechanism for rotatably driving a deflection mirror between a laser light source and a fly-eye lens, an optical member having a special shape for changing an apparent optical path with respect to each divided light flux, or the like is provided for a purpose of suppressing the generation of the interference fringe caused by the dividing and the multiplexing of light fluxes. Thus, the currently-available techniques are high in costs and complex in device configuration. According to this embodiment, however, such a mechanism for rotational driving, a special optical member, and so forth are unnecessary. Instead, the embodiment advantageously arranges the cylindrical lens to be in the inclined arrangement on the optical path. Therefore, it is possible to allow the interference fringe less visible with the configuration which is simple and low in costs.

### [Modifications]

Hereinafter, First to Sixth Modifications of the embodiment described above will be described. Note that the same or equivalent elements as those of the projection-type display device 1 according to the embodiment described above are denoted with the same reference numerals, and will not be described in detail.

### [First Modification]

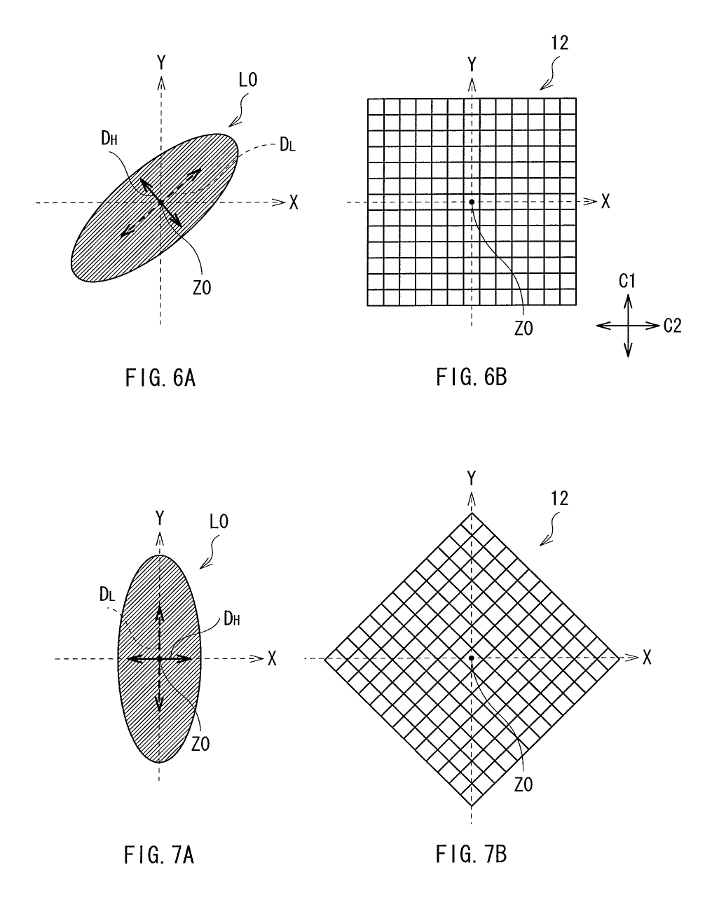

FIG. 6A illustrates a state of arrangement of the light source exit light L0 in the XY plane, and FIG. 6B illustrates a state of arrangement of the fly-eye lens 12 in the XY plane, according to a first modification. As in the embodiment described above, the first modification performs the dividing and the multiplexing of the light fluxes by the fly-eye lens 12 and the condenser lens 13 based on the exit light from the laser light source 10, in the illumination device. Also, the exit light from the condenser lens 13 is useable as the illumination light for the projection optical system having the configuration similar to that of the embodiment described above (i.e., the mirrors 14A to 14E, the transmissive liquid crystal panels 15R, 15G, and 15B, the dichroic prism 16, and the projection lens 17 are included).

The first modification differs from the embodiment described above, in that the cylindrical lens 11 is not disposed, and the light source exit light L0 directly enters the fly-eye lens 12. Also, as illustrated in FIG. 6A, the laser light source 10 is so arranged obliquely from a state of the “reference arrangement”, that the axial direction D_{H}, in which the highest coherency of light appears, in the light source exit light L0 differs from the X-direction and the Y-direction. That is, the laser light source 10 is rotated around the optical axis Z0 at a predetermined angle. Such a state of arrangement of the laser light source 10 will be hereinafter referred to as an “inclined arrangement” of the laser light source 10. On the other hand, as illustrated in FIG. 6B, the fly-eye lens 12 is arranged to have the “reference arrangement”.

In this manner, the laser light source 10 itself may have the inclined arrangement without using the cylindrical lens 11. Thus, the axial direction D_{H} in the light source exit light L0 differs from the lens-aligning directions C1 and C2 (which are equivalent to the X-direction and the Y-direction here) in the fly-eye lens 12 mutually. This makes the axial direction D_{H} of the light entering the fly-eye lens 12 and the directions of multiplexing by the condenser lens 13 (not illustrated in FIGS. 6A and 6B; see FIG. 1) to be different from one another, thereby making it possible to prevent the light rays from being multiplexed along the axial direction D_{H} in which the coherency is the highest. Therefore, it is possible to achieve an effect equivalent to that of the embodiment described above. Also, since the cylindrical lens 11 is not used in the first modification, it is possible to achieve a simpler configuration having reduced number of components.

### [Second Modification]

FIG. 7A illustrates a state of arrangement of the light source exit light L0 in the XY plane, and FIG. 7B illustrates a state of arrangement of the fly-eye lens 12 in the XY plane, according to a second modification. As in the embodiment described above, the second modification performs the dividing and the multiplexing of the light fluxes by the fly-eye lens 12 and the condenser lens 13 based on the exit light from the laser light source 10, in the illumination device. Also, the exit light from the condenser lens 13 is useable as the illumination light for the projection optical system having the configuration similar to that of the embodiment described above (i.e., the mirrors 14A to 14E, the transmissive liquid crystal panels 15R, 15G, and 15B, the dichroic prism 16, and the projection lens 17 are included). Further, the second modification has an arrangement configuration in which the cylindrical lens 11 is not disposed, and the light source exit light L0 directly enters the fly-eye lens 12, as with the first modification described before.

The second modification differs from the first modification described before, in that the laser light source 10 has the “reference arrangement”, as illustrated in FIG. 7A. Also, as illustrated in FIG. 7B, the second modification differs from the above-described embodiment and the first modification, in that the fly-eye lens 12 is so arranged obliquely from a state of the “reference arrangement” that the lens-aligning directions C1 and C2 differ from the X-direction and Y-direction mutually. That is, the fly-eye lens 12 is rotated around the optical axis Z0 at a predetermined angle. Such a state of arrangement of the fly-eye lens 12 will be hereinafter referred to as an “inclined arrangement” of the fly-eye lens 12.

In this manner, the fly-eye lens 12 itself may have the inclined arrangement without using the cylindrical lens 11. Thus, the axial direction D_{H} in the light source exit light L0 differs from the lens-aligning directions C1 and C2 in the fly-eye lens 12, mutually. This makes the axial direction D_{H} of the light entering the fly-eye lens 12 and the directions of multiplexing by the condenser lens 13 (not illustrated in FIGS. 7A and 7B; see FIG. 1) to be different from one another, thereby making it possible to prevent the light rays from being multiplexed along the axial direction D_{H} in which the coherency is the highest. Therefore, it is possible to achieve an effect equivalent to those of the embodiment and the first modification described above.

In the first and the second modifications described above, one of the laser light source 10 and the fly-eye lens 12 is arranged to have the inclined arrangement. In one embodiment, both of the laser light source 10 and the fly-eye lens 12 may be arranged to have the mutually-different inclined arrangements. That is, the laser light source 10 and the fly-eye lens 12 may be so arranged that the laser light source 10 and the fly-eye lens 12 are rotated relatively around the optical axis Z0, such that the light source exit light L0 and the lens-aligning directions C1 and C2 in the fly-eye lens 12 differ relatively. Thus, the laser light source 10 and the 10 and the fly-eye lens 12 may be so arranged that the direction, in which the highest coherency of light appears in the emitted light flux from the laser light source 10, is different from the directions of multiplexing.

### [Third Modification]

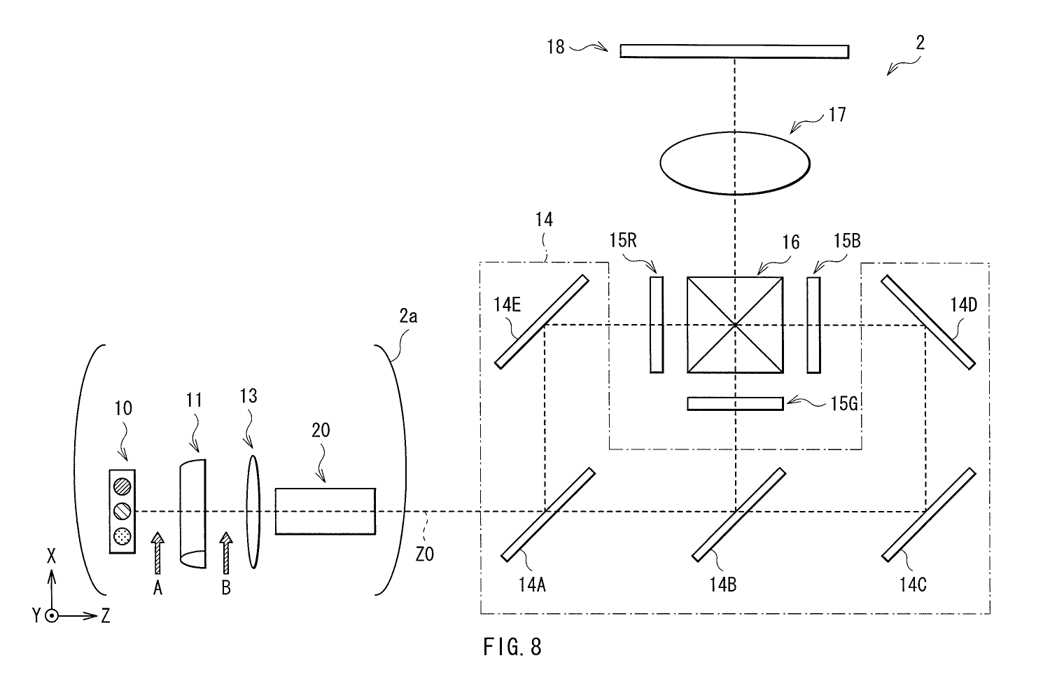

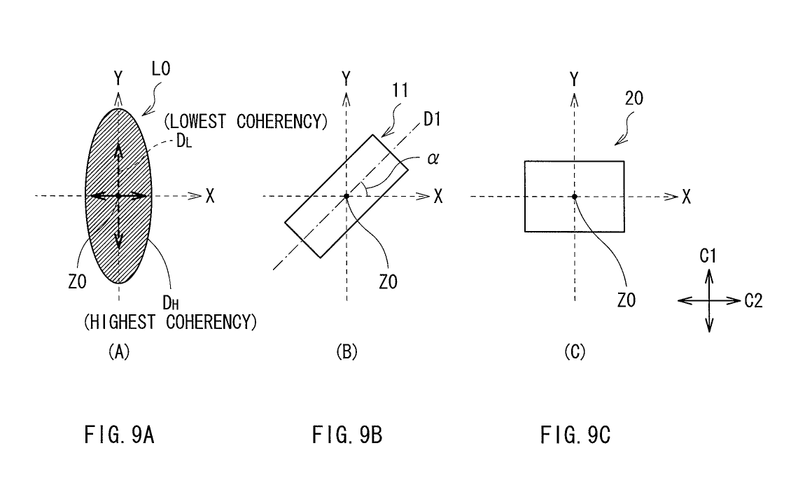

FIG. 8 illustrates an overall configuration of a projection-type display device 2 (a projection-type image display device) according to a third modification. As with the projection-type display device 1 according to the embodiment described above, the projection-type display device 2 illuminates the illumination light, derived from the exit light from the laser light source 10, from an illumination device 2a to the projection optical system (including the mirrors 14A to 14E, the transmissive liquid crystal panels 15R, 15G, and 15B, the dichroic prism 16, and the projection lens 17). Also, the laser light source 10 is arranged to have the reference arrangement as illustrated in FIG. 9A, and the cylindrical lens 11 is arranged to have the inclined arrangement as illustrated in FIG. 9B.

The third modification differs from the embodiment described above, in that a rod-type light integrator (hereinafter simply referred to as a “rod integrator”) 20 is used as the optical member for dividing and multiplexing the light fluxes. More specifically, the rod integrator 20 is disposed between the cylindrical lens 11 and the mirror 14A, instead of the fly-eye lens 12 and the condenser lens 13 according to the embodiment described above. Herein, the condenser lens 13 is disposed on a light-incident side of the rod integrator 20.

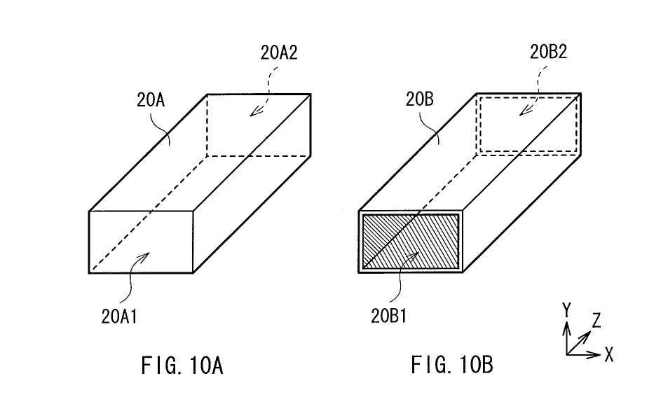

FIGS. 10A and 10B each illustrate an example of the rod integrator 20. The rod integrator 20 can be a quadrangular prism-like glass rod 20A as illustrated in FIG. 10A, for example. The glass rod 20A has a light-incident face 20A1 and a light-exit face 20A2 which are opposed to each other. The plane shape of the light-incident face 20A1 and that of the light-exit face 20A2 can be rectangular, for example. Such a configuration illustrated in FIG. 10A allows the light flux entered from the light-incident face 20A1 to be virtually-divided through multiple times of total reflection corresponding to a divergence angle of the incident light and to a length of the rod integrator 20 (a length along a Z-axis direction), and allows the divided light fluxes to be multiplexed thereafter toward the light-exit face 20A2. Thereby, the in-plane luminance in the exit light is uniformized.

Alternatively, as illustrated in FIG. 10B, the rod integrator 20 can be a quadrangular prism-like hollow body 20B whose inner surfaces are mirror surfaces, for example. The hollow body 20B has a light-incident face (a light-incident opening) 20B1 and a light-exit face (a light-exit opening) 20B2 which are opposed to each other. The plane shape (an opening shape) of the light-incident face 20B1 and that (an opening shape) of the light-exit face 20B2 can be rectangular, for example. Such a configuration illustrated in FIG. 10B allows the light flux entered from the light-incident face 20B1 to be virtually-divided through multiple times of total reflection corresponding to a divergence angle of the incident light and to a length of the rod integrator 20, and allows the divided light fluxes to be multiplexed thereafter toward the light-exit face 20B2. Thereby, the in-plane luminance in the exit light is uniformized.

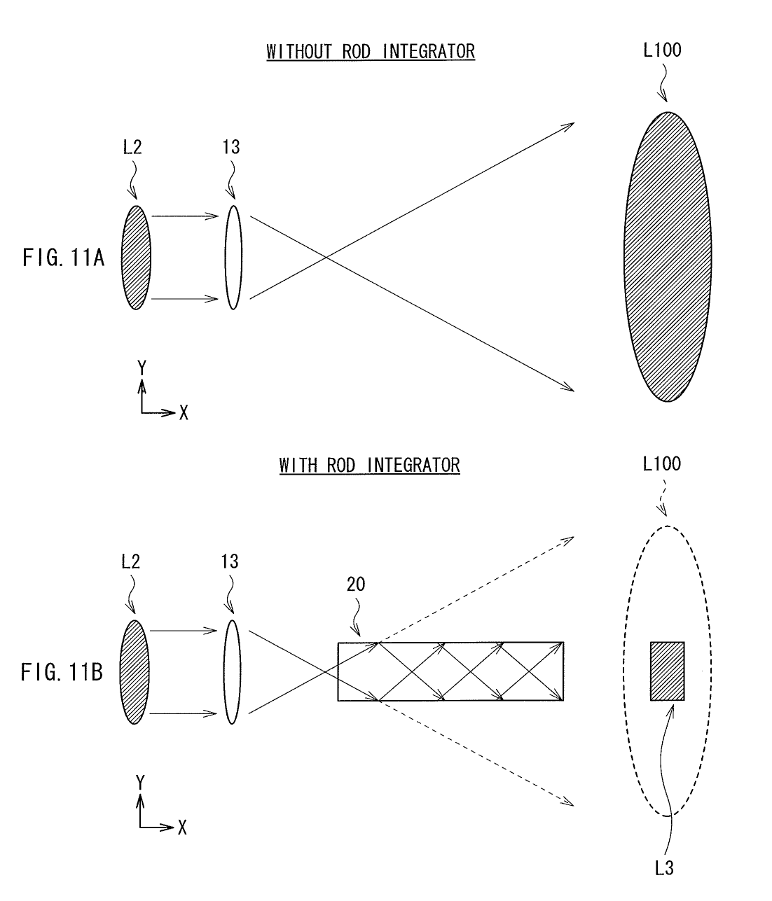

In the following, a principle of the rod integrator 20 according to this modification will be described with reference to FIGS. 11A and 11B. When the rod integrator 20 is unused, a laser light (L2) incident on the condenser lens 13 is collected by the condenser lens 13, and the collected light then diffuses (a laser light L100 illustrated in FIG. 11A). On the other hand, when the rod integrator 20 is used, the laser light L2 is collected by the condenser lens 13, and the collected light then enters the rod integrator 20. The entered light repeats the total reflection for multiple times inside of the rod integrator 20, by which the light is virtually-divided into a plurality of light rays. Thus, the light rays are multiplexed (a laser light L3 in illustrated FIG. 11B) in the light-exit face of the rod integrator 20, according to a size and a shape of the light-exit face (or the opening) thereof.

Referring to FIG. 9C, the rod integrator 20 is so arranged that a long side and a short side, in the plane shape parallel to the light-incident face and the light-exit face thereof, are along the X-direction and the Y-direction, respectively. The multiplexing by the rod integrator 20 is carried out in directions along the reflecting surfaces (wall surfaces) thereof. That is, in this modification, the directions of multiplexing by the rod integrator 20 are in the X-direction and the Y-direction. Such a state of arrangement of the rod integrator 20 will be hereinafter referred to as a “reference arrangement” of rod integrator 20.

According to the third modification, the cylindrical lens 11 is arranged to have the inclined arrangement between the laser light source 10 and the rod integrator 20. Thereby, the light source exit light L0 (a light traveling along an optical path A in FIG. 8) is rotated in the cylindrical lens 11, and then exits from the cylindrical lens 11. Thus, the axial direction D_{H} in the light, which enters the rod integrator 20 after exiting from the cylindrical lens 11 (a light traveling along an optical path B in FIG. 8), and the directions of multiplexing in the rod integrator 20, become different from one another, thereby making it possible to prevent the light rays from being multiplexed along the axial direction D_{H} in which the coherency is the highest. Therefore, it is possible to achieve an effect equivalent to that of the embodiment described above.

### [Fourth Modification]

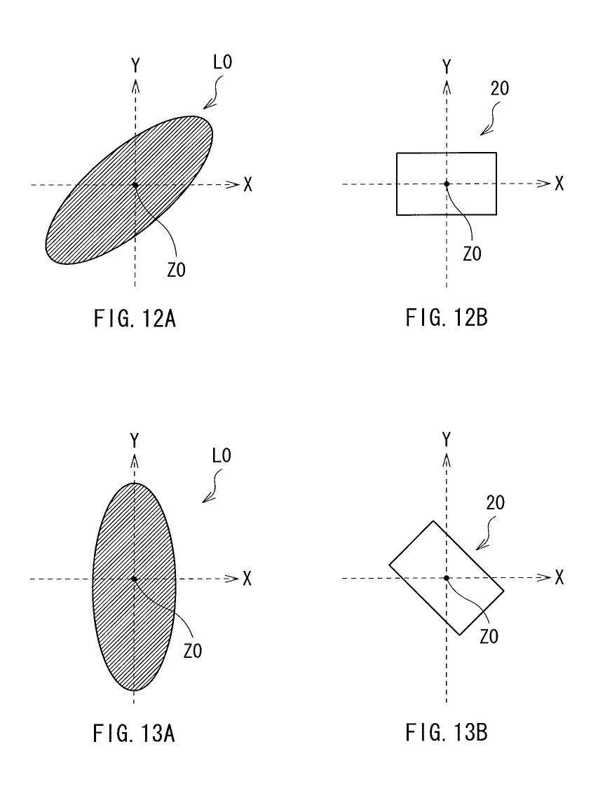

FIG. 12A illustrates a state of arrangement of the light source exit light L0 in the XY plane, and FIG. 12B illustrates a state of arrangement of the rod integrator 20 in the XY plane, according to a fourth modification. As in the third modification described above, the fourth modification performs the dividing and the multiplexing of the exit light from the laser light source 10 in the rod integrator 20, in the illumination device. Also, the exit light from the rod integrator 20 is useable as the illumination light for the projection optical system having the configuration similar to that of the embodiment described above (i.e., the mirrors 14A to 14E, the transmissive liquid crystal panels 15R, 15G, and 15B, the dichroic prism 16, and the projection lens 17 are included).

The fourth modification differs from the embodiment and the third modification described above, in that the cylindrical lens 11 is not disposed, and the light source exit light L0 directly enters the rod integrator 20. Also, as illustrated in FIG. 12A, the laser light source 10 is arranged to have the inclined arrangement, whereas the rod integrator 20 is arranged to have the reference arrangement as illustrated in FIG. 12B.

In this manner, the laser light source 10 itself may have the inclined arrangement without using the cylindrical lens 11. Thus, the axial direction D_{H} in the light source exit light L0 and the directions of multiplexing in the rod integrator 20 become different from one another, thereby making it possible to prevent the light rays from being multiplexed along the axial direction D_{H} in which the coherency is the highest. Therefore, it is possible to achieve an effect equivalent to that of the third modification described above. Also, since the cylindrical lens 11 is not used in this modification, it is possible to achieve a simpler configuration having reduced number of components.

### [Fifth Modification]

FIG. 13A illustrates a state of arrangement of the light source exit light L0 in the XY plane, and FIG. 13B illustrates a state of arrangement of the rod integrator 20 in the XY plane, according to a fifth modification. As in the third modification described above, the fifth modification performs the dividing and the multiplexing of the exit light from the laser light source 10 in the rod integrator 20, in the illumination device. Also, the exit light from the rod integrator 20 is useable as the illumination light for the projection optical system having the configuration similar to that of the embodiment described above (i.e., the mirrors 14A to 14E, the transmissive liquid crystal panels 15R, 15G, and 15B, the dichroic prism 16, and the projection lens 17 are included). Further, the fifth modification has an arrangement configuration in which the cylindrical lens 11 is not disposed, and the light source exit light L0 directly enters the rod integrator 20, as with the fourth modification described before.

In this modification, the laser light source 10 has the “reference arrangement” as illustrated in FIG. 13A. On the other hand, the rod integrator 20 is so arranged obliquely from a state of the “reference arrangement” that the directions of multiplexing thereof differ from the X-direction and Y-direction mutually, as illustrated in FIG. 13B. That is, the rod integrator 20 is rotated around the optical axis Z0 at a predetermined angle. Such a state of arrangement of the rod integrator 20 will be hereinafter referred to as an “inclined arrangement” of the rod integrator 20.

In this manner, the rod integrator 20 itself may have the inclined arrangement without using the cylindrical lens 11. Thus, the axial direction D_{H} in the light source exit light L0 and the directions of multiplexing in the rod integrator 20 become different from one another, thereby making it possible to prevent the light rays from being multiplexed along the axial direction D_{H} in which the coherency is the highest. Therefore, it is possible to achieve an effect equivalent to those of the third and the fourth modifications described above.

In the fourth and the fifth modifications described above, one of the laser light source 10 and the rod integrator 20 is arranged to have the inclined arrangement. In one embodiment, both of the laser light source 10 and the rod integrator may be arranged to have the mutually-different inclined arrangements. That is, the laser light source 10 and the rod integrator 20 may be so arranged that the laser light source 10 and the rod integrator 20 are rotated relatively around the optical axis Z0, such that the light source exit light L0 and the directions of multiplexing in the rod integrator 20 differ relatively. Thus, the laser light source 10 and the rod integrator 20 may be so arranged that the direction, in which the highest coherency of light appears in the emitted light flux from the laser light source 10, is different from the directions of multiplexing.

### [Sixth Modification]

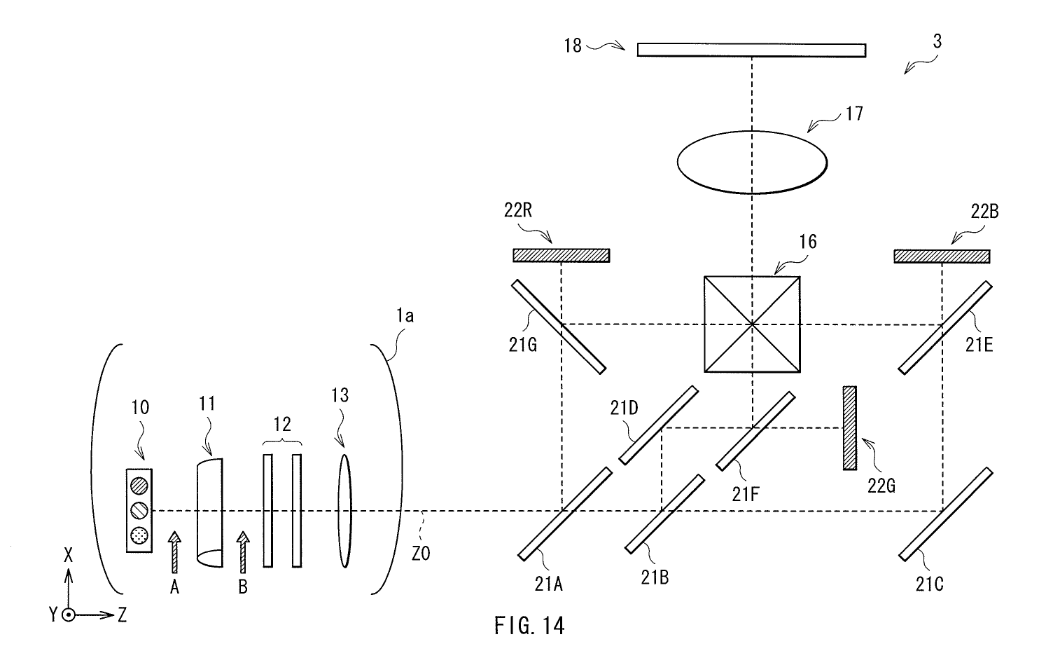

FIG. 14 illustrates an overall configuration of a projection-type display device 3 (a projection-type image display device) according to a sixth modification. The projection-type display device 3 includes the illumination device 1a which is similar to that of the projection-type display device 1 according to the embodiment described above. Also, the dichroic prism 16 and the projection lens 17 in the projection optical system and the screen 18 are similar to those in the embodiment described above as well. However, the sixth modification differs from the above-described embodiment, in that reflective liquid crystal panels 22R, 22G, and 22B are used as the liquid crystal panels in the projection optical system. Also, mirrors 21A to 21F for separating the illumination light emitted from the illumination device 1a into three color lights, and for guiding the color lights to the reflective liquid crystal panels 22R, 22G, and 22B, are provided.

Each of the reflective liquid crystal panels 22R, 22G, and 22B modulates the illumination light from the illumination device 1a based on the image signal and reflects the same, so as to allow the thus-created image light to exit toward the same side as the side on which the light has entered. Each of the reflective liquid crystal panels 22R, 22G, and 22B includes a reflective liquid crystal device, which can be LCoS (Liquid Crystal on Silicon) or other suitable reflective liquid crystal device.

The mirrors 21A to 21D separate the illumination light into red light, green light, and blue light (types of colors and the number of colors are not limited thereto), and guide each of the separated color lights to the reflective liquid crystal panel 22R, 22G, or 22B of a corresponding color. Among those mirrors 21A to 21D, the mirror 21A selectively reflects the red light, and selectively transmits the green light and the blue light therethrough. The mirror 21B selectively reflects the green light, and selectively transmits the blue light therethrough. Each of the mirrors 21E-21G selectively transmits a particular polarization light (such as an S-polarization light) therethrough, and selectively reflects other polarization light (such as a P-polarization light). In each of the reflective liquid crystal panel 22R, 22G, and 22B, the polarization light at the time of incidence thereon and the polarization light at the time of exit therefrom are made to be different from one another. More specifically, the color lights having passed through the mirrors 21A-21D first transmits through the mirrors 21E-21G. Then, the color lights enter the corresponding reflective liquid crystal panels 22R, 22G, and 22B, respectively. Then, since the color lights exit as the image lights from the reflective liquid crystal panels 22R, 22G, and 22B are the polarization lights which are different from those at the time of incidence thereon, those color lights are reflected by the mirrors 21E-21G, and the reflected color lights then enter the dichroic prism 16, respectively.

As in the embodiment described above, in the projection-type display device 3 according to this modification, the light emitted from the laser light source 10 first passes through the cylindrical lens 11, and then enters the fly-eye lens 12 to be divided therein, in the illumination device 1a. Then, the light divided in the fly-eye lens 12 is multiplexed in the condenser lens 13, and the multiplexed light exits from the condenser lens 13 as the illumination light. Then, the illumination light is separated by the mirrors 21A to 21G into the three color lights of the red light, the green light, and the blue light, which are then guided and enter the reflective liquid crystal panels 22R, 22G, and 22B, respectively. Then, these color lights are modulated in the reflective liquid crystal panels 22R, 22G, and 22B, and the modulated color lights exit therefrom as the image lights, respectively. Then, the image lights of the respective colors are synthesized in the dichroic prism 16. Then, the synthesized light is projected on the screen 18 in an enlarged fashion by the projection lens 17. Thereby, image displaying is performed. Herein, the cylindrical lens 11 is arranged to have the inclined arrangement. Thus, the multiplexing of the incident light entering the fly-eye lens 12 (a light traveling along an optical path B in FIG. 14) in the lens-aligning direction of the fly-eye lens 12, i.e., the multiplexing along the axial direction D_{H} in which the coherency is the highest of the incidence light, is avoided. Therefore, it is possible to achieve an effect equivalent to that of the embodiment described above.

Although the invention has been described in the foregoing by way of example with reference to the embodiment and the modifications, the invention is not limited thereto but may be modified in a wide variety of ways. For example, in the embodiment and the modifications described above, the cylindrical lens 11 is inclinedly arranged between the laser light source 10 and the light-dividing-multiplexing member, in order to allow the axial direction, in which the highest coherency of light appears, and the directions of multiplexing to be different from one another. However, other member may be arranged in place of the cylindrical lens 11. In one embodiment, a so-called dove prism may be disposed to rotate the plane shape of the exit light from the laser light source 10. In this embodiment, a loss in light amount may be increased when this configuration is applied to a liquid crystal device, since a polarization direction of the exit light is rotated by passing through the dove prism. The rotation of the polarization direction may be corrected by using a wave plate, although this may incur rise in costs due to increase in the number of optical components and retaining components. Thus, use of the cylindrical lens is preferable for a display device in which liquid crystal panels are used, such as any one of those according to the embodiment and the modifications, in terms of better light-use efficiency and costs as compared with the embodiment of using the dove prism.

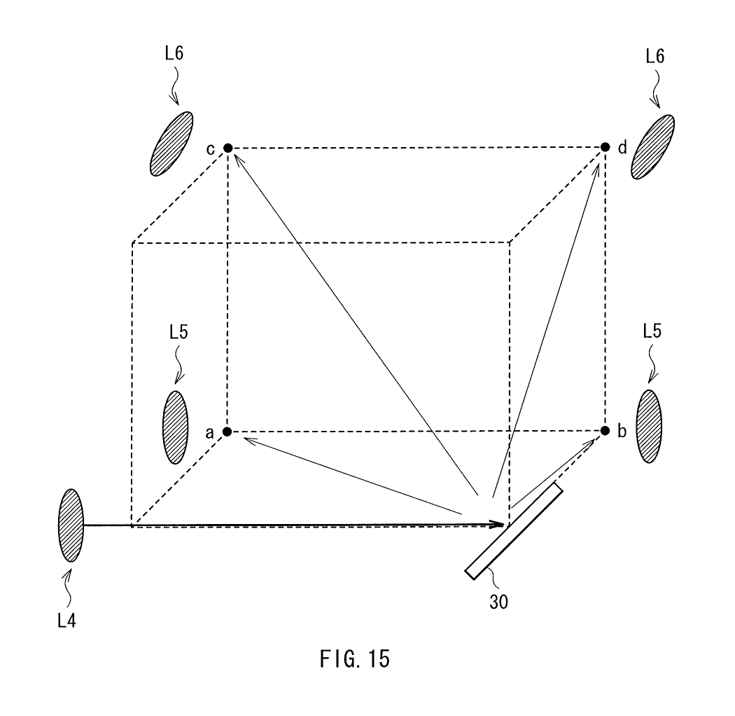

In an alternative embodiment, a mirror may be disposed between the laser light source 12 and the light-dividing-multiplexing member to rotate the plane shape of the light source exit light L0. In this embodiment, a property of laser light described below is utilized to rotate the plane shape of the light source exit light L0. Referring to FIG. 15, when a laser light L4 as the incident light is reflected using the mirror 30 toward the points a, b, c, and d, the plane shape does not rotate in the point “a” direction and in the point “b” direction (L5), but the plane shape inclines or rotates in the point “c” direction and in the point “d” direction (L6). Thus, it is possible to achieve an effect equivalent to that of any one of the embodiment and the modifications in which the cylindrical lens 11 is inclinedly arranged as described above, by so disposing the mirror on an optical path that the plane shape of the laser light is inclined. In this embodiment, an ordinary total reflecting mirror is useable, although a special mirror such as a polarizing mirror or the like may also be used.

Further, the initial embodiment and the modifications each describe the projection-type display device provided with the projection optical system. However, applications of the illumination devices according to the initial embodiment and the modifications are not limited thereto. The principles of the invention described above are applicable to any devices which utilize a laser light as a source of light. The principles described above may be applied, for example but not limited to, to an exposure system, which can be a stepper or the like.

Although the invention has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. Moreover, no element or component in this disclosure is intended to be dedicated to the public regardless of whether the element or component is explicitly recited in the following claims.

What is claimed is:

1. A light source, comprising:
a light emitter that emits a light beam along a first axis, the light beam having a highest degree of anisotropic coherency in a second axis perpendicular to the first axis; and
a light multiplexer positioned optically downstream of the light emitter, the multiplexer having an axis of multiplexing perpendicular to the first axis, the second axis and the axis of multiplexing being oriented at an angle with respect to each other that is other than 0, 90, 180 and 270 degrees.

2. The light source of claim 1, wherein the light emitter is a laser.

3. The light source of claim 2, wherein the laser is a laser diode.

4. The light source of claim 1, comprising an optical member which divides light.

5. The light source of claim 4 wherein the optical member which divides light is a fly-eye lens.

6. The light source of claim 1 comprising a lens between the light emitter and the light multiplexer.

7. The light source of claim 6, wherein the lens is a cylindrical lens.

8. The light source of claim 1, wherein the multiplexer is a condenser lens.

9. The light source of claim 1, wherein the multiplexer is a rod-type light integrator.

10. The light source of claim 1, wherein the optical member that divides light is a rod-type light integrator.

11. The light source of claim 1, comprising a dove-prism between the light emitter and the light multiplexer.

12. The light source of claim 1, comprising a mirror between the light emitter and the light multiplexer.

13. The light source of claim 1, comprising:
a cylindrical lens between the light emitter and the light multiplexer;
a condenser lens as the light multiplexer; and
a fly-eye lens between the cylindrical lens and the fly-eye lens,
wherein,
the light emitter is configured to emit the light beam along the first axis to have a highest degree of anisotropic coherency in a third axis perpendicular to the first axis,
the axis of multiplexing and the third axis are oriented at an angle of 0, 90, 180 or 270 degrees with respect to each other, and
the cylindrical lens is rotated about the first axis relative to the axis of multiplexing to cause the axis of multiplexing and the second axis to be oriented at an angle with respect to each other of other than 0, 90, 180 and 270 degrees.

14. The light source of claim 1, comprising:
a condenser lens as the light multiplexer; and
a fly-eye lens between the cylindrical lens and the fly-eye lens,
wherein,
the light emitter is configured to emit the light beam along the first axis to have a highest degree of anisotropic coherency in a third axis perpendicular to the first axis,
the light emitter is rotated about the first axis relative to the axis of multiplexing to cause the axis of multiplexing and the second axis to be oriented at an angle with respect to each other of other than 0, 90, 180 and 270 degrees.

15. The light source of claim 1, comprising:
a condenser lens as the light multiplexer; and
a fly-eye lens between the cylindrical lens and the fly-eye lens,
wherein,
the light emitter is configured to emit the light beam along the first axis to have a highest degree of anisotropic coherency in a third axis perpendicular to the first axis,
the axis of multiplexing and the third axis are oriented at an angle of 0, 90, 180 or 270 degrees with respect to each other, and
the fly-eye lens is rotated about the first axis relative to the axis of multiplexing to cause the axis of multiplexing and the second axis to be oriented at an angle with respect to each other of other than 0, 90, 180 and 270 degrees.

16. The light source of claim 1, comprising:
a cylindrical lens between the light emitter; and
a rod-type light integrator as the multiplexer,
wherein,
the light emitter is configured to emit the light beam along the first axis to have a highest degree of anisotropic coherency in a third axis perpendicular to the first axis,
the axis of multiplexing and the third axis are oriented at an angle of 0, 90, 180 or 270 degrees with respect to each other, and
the cylindrical lens is rotated about the first axis relative to the axis of multiplexing to cause the axis of multiplexing and the second axis to be oriented at an angle with respect to each other of other than 0, 90, 180 and 270 degrees.

17. The light source of claim 1, further comprising a rod-type light integrator,
wherein,
the light emitter is configured to emit the light beam along the first axis to have a highest degree of anisotropic coherency in a third axis perpendicular to the first axis,
the light emitter is rotated about the first axis relative to the axis of multiplexing to cause the axis of multiplexing and the second axis to be oriented at an angle with respect to each other of other than 0, 90, 180 and 270 degrees.

18. The light source of claim 1, further comprising a rod-type light integrator,
wherein,
the light emitter is configured to emit the light beam along the first axis to have a highest degree of anisotropic coherency in a third axis perpendicular to the first axis; and
the rod-type integrator is rotated about the first axis relative to the third axis to cause the axis of multiplexing and the second axis to be oriented at an angle with respect to each other of other than 0, 90, 180 and 270 degrees.

19. An illumination device, comprising:
a light source comprising (a) a light emitter that emits a light beam along a first axis with a highest degree of anisotropic coherency in a second axis perpendicular to the first axis and (b) a light multiplexer positioned optically downstream of the light emitter, the multiplexer having an axis of multiplexing perpendicular to the first axis, the second axis and the axis of multiplexing are oriented at an angle with respect to each other that is other than 0, 90, 180 and 270 degrees.

20. A display device, comprising:
an illumination device comprising (a) a light emitter that emits a light beam along a first axis with a highest degree of anisotropic coherency in a second axis perpendicular to the first axis and (b) a light multiplexer positioned optically downstream of the light emitter, the multiplexer having an axis of multiplexing perpendicular to the first axis, the second axis and the axis of multiplexing are oriented at an angle with respect to each other that is other than 0, 90, 180 and 270 degrees;
a light divider configuration to divide light from the illumination device into different beams; and
a light synthesizer to combine different light beams from the light divider configuration.

21. The display device of claim 19, wherein, the light divider comprising a configuration of mirrors and light valves.

22. The display of claim 19, wherein the light synthesizer comprises a dichroic prism.

23. The display of claim 19, wherein the light divider comprises a configuration of mirrors and reflective liquid crystal panels.

24. A display projector, comprising:
an illumination device comprising (a) a light emitter that emits a light beam along a first axis with a highest degree of anisotropic coherency in a second axis perpendicular to the first axis and (b) a light multiplexer positioned optically downstream of the light emitter, the multiplexer having an axis of multiplexing perpendicular to the first axis, the second axis and the axis of multiplexing are oriented at an angle with respect to each other that is other than 0, 90, 180 and 270 degrees;
a light divider configuration to divide light from the illumination device into different beams;
a light synthesizer to combine different light beams from the light divider configuration; and
a projection lens to focus light from the light synthesizer.

25. A projection display configuration, comprising:
an illumination device comprising (a) a light emitter that emits a light beam along a first axis with a highest degree of anisotropic coherency in a second axis perpendicular to the first axis and (b) a light multiplexer positioned optically downstream of the light emitter, the multiplexer having an axis of multiplexing perpendicular to the first axis, the second axis and the axis of multiplexing are oriented at an angle with respect to each other that is other than 0, 90, 180 and 270 degrees;
a light divider configuration to divide light from the illumination device into different beams;
a light synthesizer to combine different light beams from the light divider configuration;
a projection lens to focus light from the light synthesizer; and
a display screen onto with light from the projections lens is projected.
